(19) United States
(12) Patent Application Publication
(10) Pub. No.: US 2004/0233780 A1
(43) Pub. Date: Nov. 25, 2004

(54) Disposal for agitator tank

(76) Inventor: Helton Mendes de Oliveira Picho, Uberaba - MG (BR)

Correspondence Address: Michael G. Petit, P. O. Box 91929, Santa Barbara, CA, 93190-1929, US

(21) Appl. No.: 10/877,689

(22) Filed: Jun. 25, 2004

(30) Foreign Application Priority Data
Oct. 25, 2002 (BR) MU-8203013-3

(51) Int. Cl. B01F 7/00

(52) U.S. Cl. 366/279

(57) ABSTRACT

An agitator tank, used in industrial processing, that includes a tank having a substantially cylindrical interior chamber operable for containment of a material to be processed, two sets of counter-rotating blades disposed within the interior chamber of the tank and mounted on concentric axes, motor drives for each set of blades and, preferably, a turbine disposed in the base of the tank for resuspending settled material for processing. The two sets of blades include a first set of central blades which rotate counterclockwise; and a second set of peripheral blades mounted on a cylindrical frame which rotates clockwise, both sets of blades being mounted on separate, independent axes that are both centered on a single geometric axis of the cylindrical interior chamber of the tank.

### BACKGROUND OF THE INVENTION

1. Field of the Invention

The present invention relates to an agitator tank for the industrial processing of a material, and, more particularly, to an agitator tank that includes two coaxially mounted, counter-rotating members, each member supporting agitator blades disposed within the tank.

2. Prior Art

Agitator tanks useful for the processing of industrially important materials are well known in the art. Such prior art agitator tanks generally include the tank itself, which receives the product to be processed; blades supported by an axial blade-supporting member disposed inside the tank, which act on the product; and a blade drive system, which includes substantially the motor and a transmission disposed between the motor and the axial blade-supporting member. In the usual form of prior art agitators, the transmission includes a planetary system that complicates its construction.

Another inconvenience in prior art agitators is that the agitator is relatively slow in the processing of certain products. Accordingly, it is an objective of this invention to provide an agitator tank that overcomes some of the limitations of prior art agitator tanks, and to provide an agitator tank that not only offers the above advantage, but also has a lower cost compared with prior art agitator tanks.

### SUMMARY

The present invention is directed to an agitator tank for processing a material that substantially obviates one or more of the limitations of the related art. To achieve these and other advantages and in accordance with the purpose of the invention, as embodied and broadly described herein, the agitator tank of the present invention includes essentially: (a) a substantially cylindrical tank operable for receiving the product to be processed; (b) a set of rotatably mounted blades which acts on the product, the set of blades including a first subset of central blades mounted directly on a first axis axially mounted on the tank which rotates counterclockwise, and a second subset of peripheral blades mounted on a frame which rotates clockwise, the second subset of blades, which also acts on the product, being directed inwardly from the frame towards the center of the tank, both the first and second subset of blades rotatably, but independently mounted about a single geometrical axis; and (c) a drive set for the first and second subsets of blades comprising two sets of electrical motors and reducers mounted on respective bases that are preferably attached to the top of the tank. One of the motor-reducer sets is attached to a superior extension of the first axis supporting the first subset of blades, and the other motor-reducer set to an external sleeve affixed to the frame and concentrically and sealingly mounted to the axis and linked to the midpoint of the superior side of the frame. The inferior extreme of the axis and the inferior side of the frame are journalled one to another at the bottom of the tank thereby closing the interstice between the superior lid of the tank and the sleeve. In a preferred embodiment, the agitator tank of the present invention includes a disposal comprised of a lateral turbine which may be employed for resuspending or removing settled material. The agitator tank may further be characterized by the presence of a frequency alternator operable for changing the speed of rotation of the blades.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a longitudinal cross-sectional schematic view of a first embodiment of an agitator tank in accordance with the present invention.

FIG. 2 is a longitudinal cross-sectional schematic view of a second preferred embodiment of an agitator tank in accordance with the present invention wherein the agitator tank further comprises a disposal unit attached thereto.

### DESCRIPTION OF THE PREFERRED EMBODIMENTS

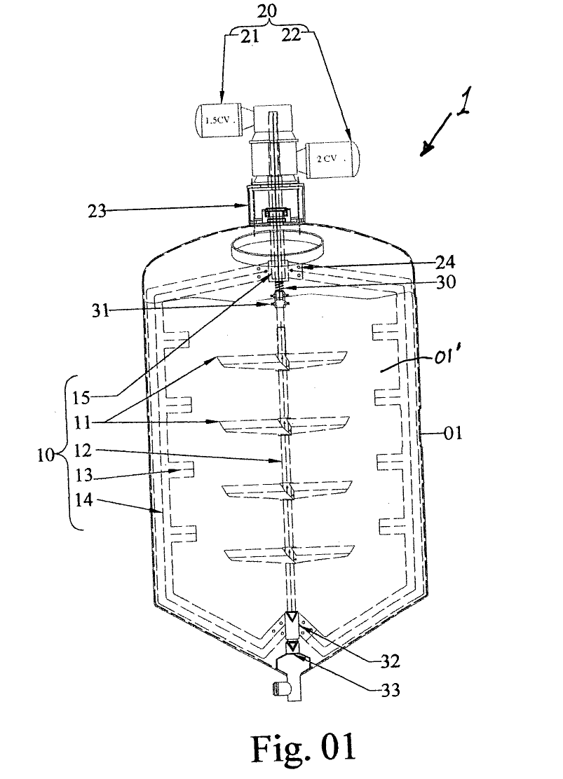

With reference to FIG. 1 an agitator tank in accordance with a first embodiment of the present invention is indicated at numeral 1. The agitator tank 1 was developed for the processing of cream products and similar products, but it will be apparent to those skilled in the art that the agitator tank 1 may be used for processing a variety of materials. The agitator tank 1 includes a tank 01 having a cylindrical interior chamber 01′ that receives the product to be processed; a set of blades 10 which acts on the product, and a set of blade drives 20. The set of blades 10 which act on the product is comprised essentially of a first subset of central blades 11, with counterclockwise rotation mounted directly on an axis 12 disposed axially within the tank 01, and a second subset of peripheral blades 13 with clockwise rotation mounted on a frame 14 and projecting inwardly from the frame 14 toward the center of the tank 01.

The drive set 20 is formed by two sets 21, 22 of electrical motors and reducers mounted on a base 23 attached to the top of the tank 01. Motor-reducer set 21 is attached to the superior extension of the axis 12 and the other motor-reducer set 22 to a external sleeve 24 concentric to the axis 12 linked to the mid-point of the top side of the frame 14. The low extreme of the axis 12 and the low side of the frame 14 are journalled one to another at the bottom of the tank 01 as indicated at numerals 32 and 33.

In order to close the interstice between the superior lid of the tank 01 and the sleeve 24 a seal ring 30 is disposed therebetween. Naturally, the agitator tank 1 is linked to hydraulic circuit operable for the feed and removal of the processed product and an electric circuit for supplying power to the motors. Thus, the agitator tank 1 works in such a way that the sets of central 11 and peripheral 13 blades rotate around a single geometrical axis and in opposite directions (counterclockwise and clockwise), providing severe agitation to the product thereby accelerating its processing.

To illustrate the efficiency of the present agitator tank 1 compared to prior art agitator tanks employed, for instance, in shampoo processing, it has been determined that the present agitator tank 1 stabilizes the foam volume in a production time of around sixteen minutes. For comparative purposes, conventional agitator tanks take around one hour and forty minutes to stabilize the foam volume. This way, the present agitator tank is more efficient than the usual one.

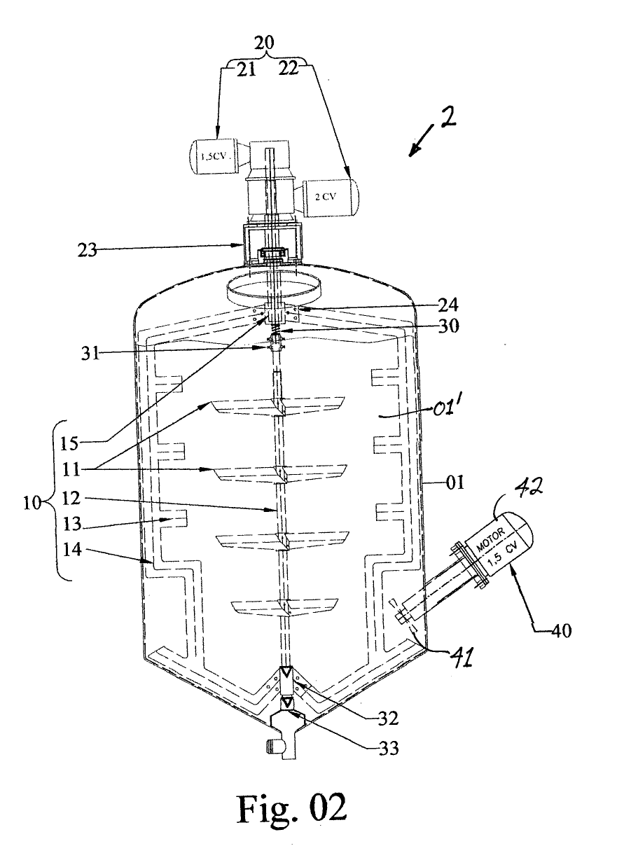

Another advantage is that the present agitator tank is of simpler construction than conventional agitator tanks, avoiding the use of complex planetary systems. The simplicity of construction reduces the cost of making and maintaining the agitator tank. The agitator tank 1 may be provided with a lateral turbine 40 to provide a second preferred embodiment 2 as illustrated in FIG. 2. The motor 42 drives an impeller 41 which may be used for the resuspension of incompletely processed material or for the removal of material from the tank. In addition, the agitator tanks 1 or 2 may be provided with a frequency variation system for speed variation.

The present tank is presently employed to process different cream products, especially to homogenize cosmetic products such as: creams, shampoos, smoothers, gels and others. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What I claim is:

1. An agitator tank comprising: (a) a tank having a superior lid operable for receiving and containing a product to be processed; (b) a set of rotatably mounted blades which acts on the product, the set of blades including: (i) a first subset of central blades mounted directly on an axis axially mounted on the tank and projecting outwardly therefrom which rotate counterclockwise, and (ii) a second subset of peripheral blades mounted on a frame which rotates clockwise, the second subset of blades directed inwardly from said frame towards a center of the tank, both said first and second subset of blades rotatably and independently mounted about a single geometrical axis; and (c) a drive set operable fro rotating said first and second subsets of blades comprising two sets of electrical motors and reducers mounted on respective bases attached to a top of said tank, one of said motor-reducer sets being attached to a superior extension of said axis supporting said first subset of blades, and said other motor-reducer set being in mechanical communication with an external sleeve concentrically and sealingly mounted to said axis and linked to a midpoint of the superior side of said frame, and wherein an inferior extreme of said axis and an inferior side of said frame are journalled one to another at a bottom of said tank thereby closing an interstice between said superior lid of said tank and said sleeve.

2. The agitator tank of claim 1 further including a disposal comprised of a motor mounted on a lower portion of said tank, said motor driving an impeller assembly disposed within the interior chamber of the tank, the disposal being operable for resuspending or removing material adjacent the impeller.

3. The agitator tank of claim 1 further comprising a frequency alternator operable for changing the speed of rotation of said blades.

4. The agitator tank of claim 2 further comprising a frequency alternator operable for changing the speed of rotation of said blades.
